(19) United States
(12) Patent Application Publication
(10) Pub. No.: US 2011/0303608 A1
(43) Pub. Date: Dec. 15, 2011

(54) Desalination System

(75) Inventor: Tony Tak-Shee Huen, Alameda, CA (US)

(73) Assignee: WAWE, LLC, Alameda, CA (US)

(21) Appl. No.: 13/109,275

(22) Filed: May 17, 2011

Related U.S. Application Data
(60) Provisional application No. 61/354,524, filed on Jun. 14, 2010.

(51) Int. Cl. C02F 1/44; B01D 63/00

(52) U.S. Cl. 210/652; 210/321.6; 210/136

(57) ABSTRACT

A desalination system is provided that may be operated in a self-sustained fashion. The desalination system is comprised of (i) a wind turbine; (ii) an air compressor coupled to, and powered by, the wind turbine; (iii) a compressed air storage tank for storing the pressurized air from the air compressor; (iv) a pneumatic actuator that is powered by compressed air stored in the air storage tank; (v) at least one compression cylinder coupled to, and powered by, the pneumatic actuator; (vi) a source of salt water that is introduced into the compression chamber(s) of the compression cylinder(s); and (vii) a reverse osmosis desalination column that is configured to receive pressurized salt water from the compression cylinder(s) and output desalinated water.

### CROSS-REFERENCE TO RELATED APPLICATION

This application claims the benefit of the filing date of U.S. Provisional Patent Application Ser. No. 61/354,524, filed 14 Jun. 2010, the disclosure of which is incorporated herein by reference for any and all purposes.

### FIELD OF THE INVENTION

The present invention relates generally to desalination systems and, more particularly, to a system and method for self-sustained desalination.

### BACKGROUND OF THE INVENTION

Water, especially fresh water, is a resource that is often taken for granted, but is frequently in short supply. Sometimes the lack of fresh water is due to the location, for example the area in question may be naturally arid and unable to support the desired population level or industries. Changing climate patterns, for example an extended period of below average rainfall or an extended period of above average temperatures, may also lead to a lack of fresh water, especially in regions in which water is already scarce. Additionally, as cities expand, the rate of growth may exceed the ability of the underlying infrastructure to keep up, leading to contamination of the underlying water supply. As a result of these and other factors, throughout the world water management has become an increasingly important topic, both in terms of water quality control and the development of adequate water resources.

Approximately half of the world's population lives within 200 kilometers of a coastline. In general, this is due to the many economic benefits associated with such regions, ranging from easy transportation links to a seemingly limitless supply of food. Unfortunately as the population densities in such regions grow, so does the stress to the region's infrastructure (e.g., waste management, water delivery systems, etc.) as well as its natural resources (e.g., marine ecosystems, air quality, water quality, native vegetation, animal wildlife, etc.). While the management of coastal regions has proven to be an extremely complex problem, especially in light of the often competing interests of the various economic groups and industries involved, water desalination is often viewed as a potential solution to the problem of obtaining an adequate supply of fresh water in these regions.

Currently, the two most commonly used desalination methods are (i) membrane reverse osmosis and (ii) thermal evaporation. Unfortunately, both of these techniques rely on carbon based fuels, either as a source of electrical power or as a source of thermal energy. Therefore while these techniques may help solve the problem of obtaining a sufficient supply of fresh water, they do so at the expense of the environment. Accordingly, what is needed is an improved method of desalination that minimizes the use of carbon-based fuels. The present invention provides such a system.

### SUMMARY OF THE INVENTION

The present invention provides a self-sustaining desalination system. The desalination system is comprised of (i) a wind turbine; (ii) an air compressor coupled to, and powered by, the wind turbine; (iii) a compressed air storage tank for storing the pressurized air from the air compressor; (iv) a pneumatic actuator that is powered by compressed air stored in the air storage tank; (v) a compression cylinder, wherein a piston corresponding to the compression cylinder is cycled by the pneumatic actuator, and wherein salt water introduced into the compression cylinder is compressed and expelled as pressurized salt water; and (vi) a reverse osmosis desalination column coupled to the output of the compression cylinder, the reverse osmosis desalination column outputting desalinated water. The desalination system may include a generator for generating electricity, where the generator may be powered by the wind turbine or combined with an air turbine that is driven by compressed air from the compressor or from the compressed air storage tank. The pneumatic actuator may be coupled to a directional valve that cycles the pneumatic actuator. The desalination system may include a diverter that includes a control valve, where the control valve in a first position couples the output from the compression cylinder to the input of the reverse osmosis desalination system, and in a second position couples a source of pressurized desalinated water to the input of the reverse osmosis desalination system.

The desalination system may include a second compression cylinder, either coupled to the same actuator rod as the first compression cylinder, or coupled to a second actuator rod of the pneumatic actuator. The system is configured such that the compression stroke of one cylinder at least partially coincides with the intake stroke of the other cylinder. The second compression cylinder compresses salt water and outputs pressurized salt water to the reverse osmosis desalination column input. In at least one configuration, check valves are coupled to each cylinder's input and each cylinder's output. In at least one configuration, a brine stream output by the reverse osmosis desalination column is introduced into the rear chamber of each compression cylinder during that cylinder's compression stroke. In at least one configuration, a first directional valve is used to control the introduction of salt water into the forward chamber of each cylinder as well as expulsion of pressurized salt water after the corresponding cylinder's compression cycle. A second directional valve may be used to control the introduction of brine into the rear chamber of each cylinder as well as its expulsion. An accumulator may be coupled to the output from each cylinder as well as the input to the reverse osmosis desalination column, the accumulator damping pressure fluctuations within the input to the reverse osmosis desalination column.

In another aspect of the invention, a method of desalinating water is provided, the method comprising the steps of (i) powering an air compressor with a wind turbine; (ii) generating compressed air and storing the compressed air within a storage tank; (iii) powering a pneumatic actuator with compressed air from the storage tank; (iv) cycling a compression piston of a compression cylinder, where the compression piston is cycled by the pneumatic actuator; (v) introducing salt water into the compression cylinder; (vi) expelling pressurized salt water from the compression cylinder; (vii) introducing the pressurized salt water into the input of a reverse osmosis desalination column; and (viii) expelling desalinated water from the output of the reverse osmosis desalination column. The method may further include the step of generating electricity with a generator (i) coupled to the wind turbine; (ii) coupled to an air turbine which is driven by compressed air from the air compressor; and/or (iii) coupled to an air turbine which is driven by compressed air stored in the air storage tank. The method may include the step of periodically introducing pressurized desalinated water into the input of the reverse osmosis desalination column rather than pressurized salt water. The method may include the steps of cycling a second compression cylinder using the pneumatic actuator; introducing salt water into the second compression cylinder; expelling pressurized salt water from the second compression cylinder; introducing the pressurized salt water into the input of the reverse osmosis desalination column; and expelling desalinated water from the output of the reverse osmosis desalination column. The method may include the steps of introducing a brine stream expelled by the reverse osmosis desalination column into the rear chambers of the first and second compression cylinders during the corresponding cylinder's compression stroke. The method may include the step of damping pressure fluctuations within the input to the reverse osmosis desalination column.

A further understanding of the nature and advantages of the present invention may be realized by reference to the remaining portions of the specification and the drawings.

### BRIEF DESCRIPTION OF THE DRAWINGS

FIG. 1 provides a high level diagram of a preferred embodiment of the invention;

FIG. 2 provides a detailed view of a water pressurization system for use in the system shown in FIG. 1;

FIG. 3 provides a detailed view of an alternate water pressurization system using a single rod pneumatic actuator;

FIG. 4 illustrates the benefits of introducing the brine stream from the reverse osmosis column into the rear chamber of the pressure multiplying cylinder(s);

FIG. 5 illustrates a water desalination system utilizing the water pressurization system shown in FIG. 2, modified to introduce the brine stream from the reverse osmosis column into the rear chambers of the pressure multiplying cylinders; and

FIG. 6 illustrates a preferred embodiment for the inverter shown in FIG. 1.

### DESCRIPTION OF THE SPECIFIC EMBODIMENTS

During the last few decades, there have been repeated attempts to utilize wind energy in the desalination process. Generally these techniques have either used wind turbines to generate electricity, which then may be used to power electric motor water pumps, or to drive the water pumps directly, for example using a windmill. While these techniques may help to alleviate the environmental impact of a water desalination system, their reliance on wind power has proven to be problematic since the wind is not constant. Even attempts to overcome this problem using batteries to store wind generated electricity have met with repeated failures. The present invention overcomes the problem of storing wind power by using a wind turbine to generate compressed air, which can then be stored and subsequently used in the disclosed desalination system.

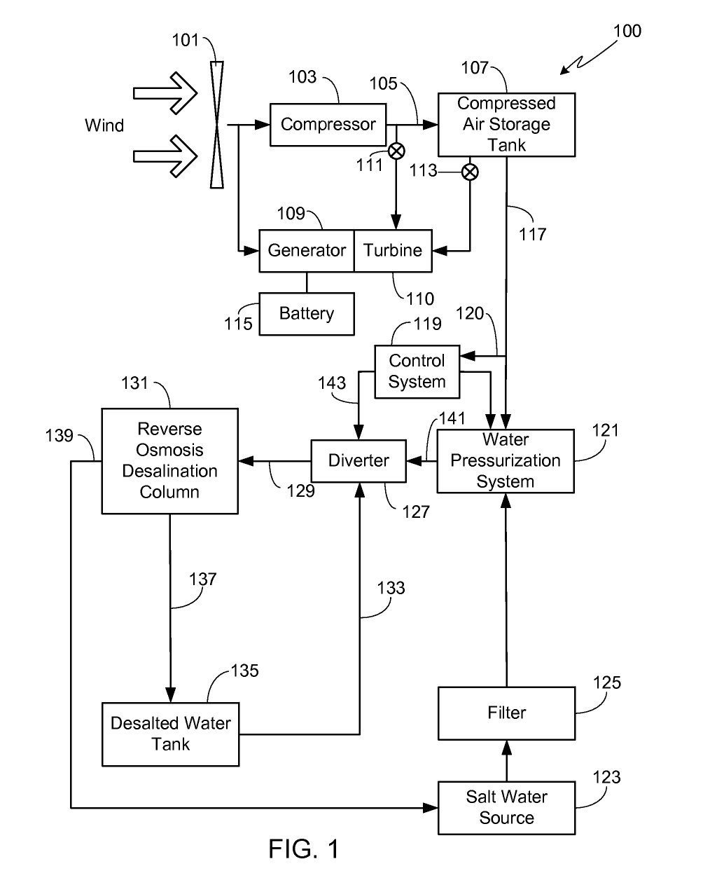

FIG. 1 provides a high level diagram of a preferred embodiment of the invention. The system uses a wind turbine 101 to drive an air compressor 103. Air compressor 103 may be a screw compressor, a reciprocating compressor, or other compressor type. The output 105 from air compressor 103 is stored within air tank 107. Although not required by the invention, wind turbine 101 may also be used to drive a generator 109 for generating electricity. Similarly, generator 109 may also be driven by compressed air, for example by coupling an air turbine 110 to generator 109, and driving air turbine 110 with pressurized air from air compressor 103 and/or storage tank 107, as shown. Note that in this configuration, it is preferable to utilize flow valves 111 and 113 to control the amount of air from air compressor 103 and tank 107, respectively, which is diverted from the desalination system and used to generate electricity. Typically the electricity generated by generator 109 is used to provide power for system controllers, communication links, and other system electronics. The generated electricity may also be stored in a rechargeable battery system 115 and/or fed into the local power grid. In general, the amount of electricity, if any, generated by system 100 will depend on the size of wind turbine 101 and the requirements of the desalination system.

Compressed air output 117 is coupled to water pressurization system 121. A control system 119 is preferably coupled to, and provides control over, water pressurization system 121. Control system 119 may be electrical, pneumatic, or electro-mechanical in design and as such, in some configurations it may be coupled to the compressed air tank via line 120. Additionally, while the output from compressor 103 may be fed directly into water pressurization system 121, the inventor has found that it is preferable to utilize output line 117 from storage tank 107. Salt water from a suitable source 123, such as the ocean, is also directed into pressurization system 121 after passing through one or more filters 125.

In at least one preferred embodiment of the invention, the pressurized water output from system 121 is routed through a diverter 127. Preferably diverter 127 is a 2-way solenoid valve that is controlled by valve control system 119. Diverter 127 directs feed stream 129 into reverse osmosis desalination column 131, where feed stream 129 is composed of either pressurized salt water from system 121 or desalinated water passing through conduit 133 from water storage tank 135. After processing by reverse osmosis column 131, the permeate water, i.e., the desalinated water, is fed into tank 135 via conduit 137. In at least one embodiment, the rejected brine concentrate stream is returned to source 123 via conduit 139. It will be appreciated that it may be necessary to treat the concentrate stream prior to returning it to source 123.

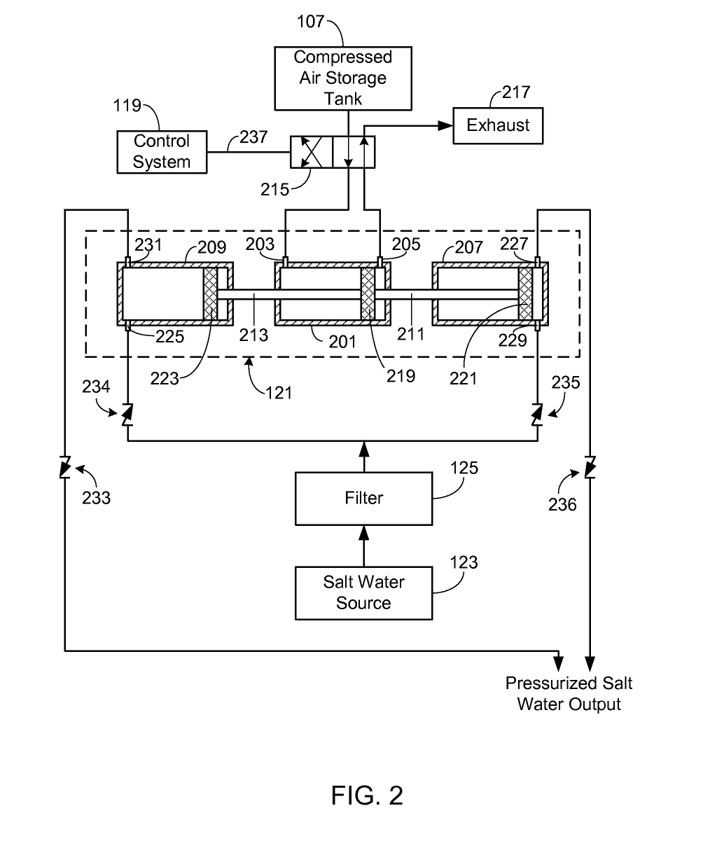

While the basic operation of a preferred embodiment of the invention has been illustrated and described above, particulars for specific aspects of the invention will now be provided. FIG. 2 illustrates operation of water pressurization system 121. In the illustrated exemplary configuration a double rod pneumatic actuator 201 is used, although it should be understood that the invention may use other types of pneumatic actuators such as a single rod actuator. Pneumatic actuator 201 includes a pair of air inputs 203 and 205 and is coupled to at least one pressure multiplying piston cylinder (e.g., a compression cylinder), and more preferably a pair of pressure multiplying piston cylinders 207 and 209 as shown. Cylinders 207 and 209 are coupled to actuator 201 via actuator arms 211 and 213, respectively. The use of a pair of pressure multiplying cylinders is preferred in order to achieve near continuous output of pressurized water, thus minimizing pressure fluctuations at the input to the reverse osmosis system which, in turn, extends the service life of the column.

In operation, the movement of pneumatic actuator 201 is driven by introducing compressed air, in a cyclic fashion, through air inputs 203 and 205. The source of the compressed air is compressed air storage tank 107. A valve 215, for example a 4-port directional valve as shown, alternately couples air inlets 203 and 205 to the source of compressed air (e.g., tank 107) and to an exhaust 217, thereby causing piston 219 within actuator 201 to cycle back and forth. When valve 215 couples the source of compressed air to inlet 203, piston 219 within the actuator moves to the right, as shown. In the illustrated push-pull arrangement, as a result of the introduction of compressed air into inlet 203, piston 221 within cylinder 207 and piston 223 within cylinder 209 each move to the right. This movement, in turn, causes cylinder 209 to withdraw filtered salt water from source 123 via inlet 225, and causes the pressurization of the salt water previously drawn into cylinder 207. The pressurized water is then expelled from cylinder 207 through cylinder outlet 227. During the next half of the cycle, the process is reversed due to the introduction of compressed air into inlet 205. As compressed air is introduced into inlet 205, the air to the left of piston 219 is exhausted via exhaust 217, salt water is drawn into cylinder 207 via inlet 229, and the salt water within cylinder 209 is pressurized before being expelled through outlet 231. Note that in the illustrated embodiment, both the intake and exhaust water lines include check valves, e.g., valves 233-236, also referred to as one-way valves. Note that valves 233-238 may be comprised of ball check valves, swing check valves, or other one-way valves. Although not shown, an accumulator may be used to dampen flow rate and pressure fluctuations in the output of cylinders 207 and 209. Control system 119 is preferably coupled to valve 215 via control line 237, control system 119 providing the necessary control signals to alternate flow of compressed air into either inlet 203 or inlet 205 of pneumatic actuator 201. In at least one embodiment, control system 119 is a programmable logic controller.

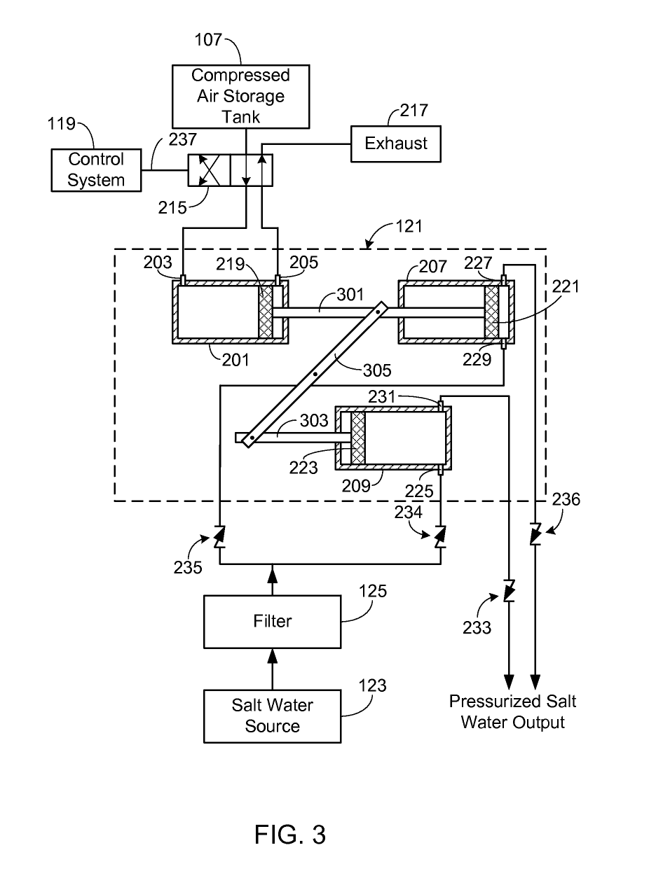

The present invention can utilize a variety of different configurations for the water pressurization system, including the use of both dual rod pneumatic actuators as described above, or single rod pneumatic actuators as shown in FIG. 3. It will be appreciated that the only difference between the water pressurization systems shown in FIGS. 2 and 3 is the manner in which the pneumatic actuator is coupled to the pressure multiplying piston cylinders 207 and 209. In the configuration shown in FIG. 3, pneumatic actuator arm 301 is linked directly to piston 221 of cylinder 207. Piston control arm 303, coupled to piston 223 of cylinder 209, is linked via control arm linkage 305 to actuator arm 301.

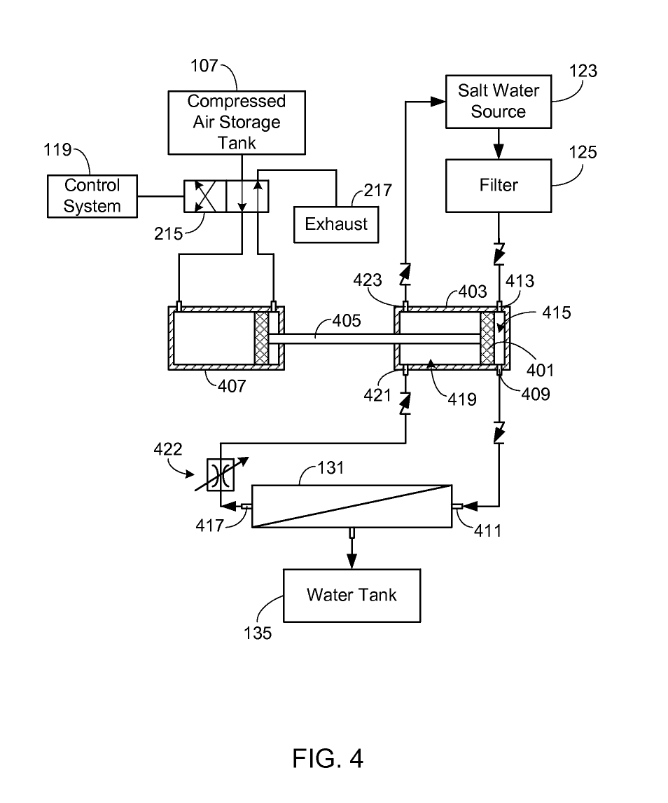

Although the present invention may operate as previously disclosed, it is possible to reduce the amount of force that must be applied by the piston control arm by introducing pressurized salt water into the rear chamber of the pressure multiplying cylinder during the compression step. This phenomenon is illustrated in FIG. 4 which shows a simplified system in which piston 401 of a single pressure multiplying cylinder 403 is coupled to the actuator arm 405 of a pneumatic actuator 407. The pressurized water output 409 of cylinder 403 is coupled to input 411 of reverse osmosis desalination column 131. As previously described, the water input 413 of cylinder 403 is coupled to a source of salt water 123.

In this configuration, during the water compression step, which takes place in the forward chamber 415 of cylinder 403, water from the brine port 417 of reverse osmosis column 131 is introduced into the rear chamber 419 of cylinder 403 via input 421. Preferably a needle valve 422 is included at the output of the brine port 417 as shown, valve 422 providing trimming adjustment of the operating pressure of reverse osmosis column 131. Introducing pressurized water into rear chamber 419 adds another force component that aids actuator rod 405 in performing the pressurization of the water in forward chamber 415. Since the force exerted by the water in the rear chamber is nearly as large as the force exerted by the water within the forward chamber, the amount of force that must be applied by actuator rod 405 can be greatly reduced. For example, for a small cylinder on the order of 4 inches in diameter and 6 inches long and a ½ inch diameter actuator rod, the force required to pressurize the water in the forward chamber to 1000 psi can be reduced from approximately 6.3 tons to approximately 200 pounds simply by introducing the brine stream output from column 131 into the rear chamber of the compression cylinder. Note that during the decompression cycle water is drawn into forward chamber 415 through port 413, and the brine fluid in the rear chamber is expelled through port 423.

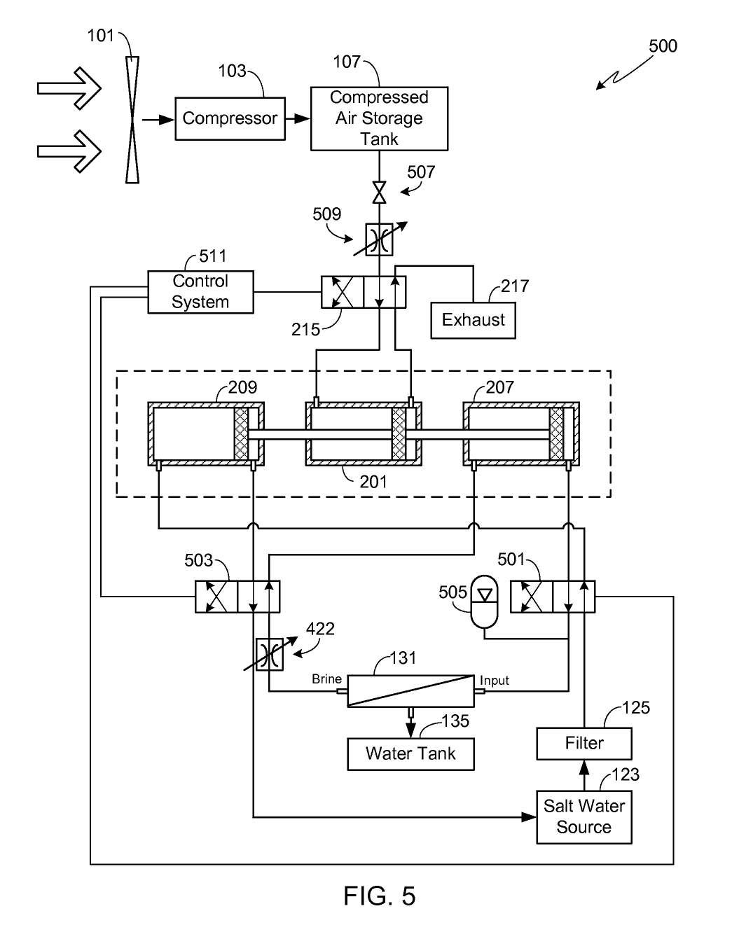

FIG. 5 illustrates the principal components of a desalination system utilizing the push-pull arrangement shown in FIG. 2. Additionally, system 500 feeds the brine stream from the reverse osmosis column into the rear chambers of the pressure multiplying cylinders as described above relative to FIG. 4. In system 500, the generator system 109 is not included although it should be understood that the inventor envisions its use in system 500. Similarly, while diverter 127 is not included in system 500, it should be understood that it may be included. Additional description of diverter 127 is provided below. Lastly and as previously noted, implementation of the present invention is not limited to a specific actuator/pressure cylinder configuration and the system shown in FIG. 5 is only meant to illustrate an exemplary and preferred embodiment.

In preferred system 500, in addition to the 4-port directional valve 215 used to direct the flow of compressed air into pneumatic actuator 201, a second directional valve 501 is used to control the flow of salt water from source 123 into the forward chambers of compression cylinders 207/209, and to control the flow of pressurized salt water from compression cylinders 207/209 to the reverse osmosis column 131. A third directional valve 503 is used to control the flow of the brine stream from reverse osmosis column 131 into the rear chambers of compression cylinders 207/209, and to control the flow of the brine stream from the rear chambers of compression cylinders 207/209 back to the salt water source 123, or to another location for use/elimination. This embodiment illustrates the use of an accumulator 505 in the input line to the reverse osmosis column 131, accumulator 505 damping flow rate and pressure fluctuations that arise due to the cyclic nature of the output from compression cylinders 207 and 209. Additionally, in order to control the air flow to valve 215, this embodiment includes a gate valve 507 (or similar valve) and a flow control valve 509 (or similar means for controlling flow rates) between the compressed air storage tank 107 and directional control valve 215.

Control system 511 represents a mechanical or electro-mechanical control system that is used to control directional valves 215, 501 and 503. In at least one embodiment, mechanical linkage is used to control mechanical push buttons on each of the directional valves. Alternately, electro-mechanical control can be used, for example using a programmable logic control module (PLC module) and electro-mechanically actuated valves/controls, thus providing the user with the ability to control operation of the desalination system remotely as well as set periods of operation. Electro-mechanical control can also be used to enable operation of a smart desalination system, for example one that varies output based on need, time of day, time of year, wind conditions, water levels within tank 135, etc. In at least one embodiment, control system 511 monitors system conditions and either automatically reports those conditions or reports those conditions when they fall outside of a desired/preset operating range, for example using an internet or cell/text messaging system to report the conditions. Exemplary conditions include wind speed at the facility, pressure within compressed air storage tank 107, water levels within tank 135, service conditions relating to reverse osmosis column 131 (e.g., hours/days of operation since last service), etc. If an electro-mechanical control system is employed, preferably the required power for operation is provided by generator 109 and/or storage battery 115.

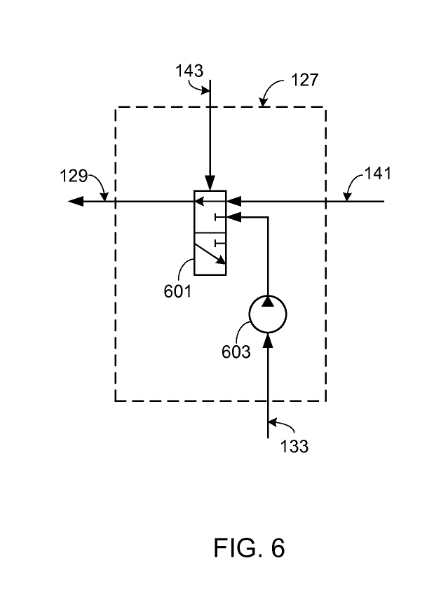

In at least one embodiment of the invention, the inventor envisions the use of a diverter 127. The purpose of diverter 127 is to periodically wash and rinse the membranes within reverse osmosis column 131 with desalinated water from source 135, thereby enhancing the operational lifetime and reliability of column 131. In the preferred embodiment of diverter 127, a control valve 601 is used to divert water flow, valve 601 preferably being a 3-port directional control valve that is in the normally open position as shown in FIG. 6. In the open position, valve 601 passes high pressure water exiting water pressurization system 121 in line 141 through to inlet line 129 of reverse osmosis column 131. When a control signal is received from control system 119 on control signal line 143, for example indicating that the membranes within column 131 are due for cleaning, valve 601 decouples line 141 from input line 129, and couples line 133 from desalinated water storage tank 135 to input line 129 of column 131. A pump 603 is used to pump desalinated water from tank 135 to column 131, thereby providing a source of pressurized desalinated water to clean the membranes of the reverse osmosis column.

While preferred embodiments of the invention have been shown and described, it should be understood that the inventor envisions variations based on the intended geographic location of the desalination system, intended throughput, expected wind conditions, availability of auxiliary power, etc. Additional considerations for some of the primary components of the desalination system are provided below.

Wind Turbine—Any of a variety of different styles and configurations may be used for wind turbine 101, ranging from a simple wind mill not unlike those commonly used in the 1800's, to the sophisticated turbines commonly used to generate electricity. For example, the present invention may be sized to utilize a relatively small wind mill; alternately, a mid-sized wind turbine with a 1-3 meter diameter rotor and a 7-15 meter tower; alternately, a large-sized wind turbine with a 3+ meter diameter rotor and a 10-25 meter tower.

Compressor—Compressor 103 is selected based on the desired output as well as ease of coupling to the wind turbine. Preferably a conventional, off-the-shelf compressor is used. In most configurations, the desired output from compressor 103 is in the range of 100 to 200 psi.

Storage Tank—As previously described, the purpose of air tank 107 is to store compressed air output by wind turbine 101 and compressor 103 for use in the desalination system. By storing the compressed air, the desalination system is not affected by temporary lulls in the wind. The primary factors used in determining the optimal size and configuration of tank 107 are (i) expected output from wind turbine 101 and compressor 103; (ii) input requirements for the desalination system; (iii) tank size limitations based on location; and (iv) the need to accommodate for lulls in the wind.

Reverse Osmosis Desalination Column—Reverse osmosis desalination columns are well known by those of skill in the industry. For the present application, the primary factor is the desired level of output.

It should be understood that identical element symbols used on multiple figures refer to the same component, or components of equal functionality. Additionally, the accompanying figures are only meant to illustrate, not limit, the scope of the invention and should not be considered to be to scale.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

What is claimed is:

1. A desalination system, comprising:
a wind turbine;
an air compressor coupled to said wind turbine, wherein said air compressor is powered by said wind turbine, said air compressor generating compressed air, and wherein said air compressor further comprises a compressed air output;
a compressed air storage tank coupled to said compressed air output of said air compressor;
a pneumatic actuator, said pneumatic actuator comprising an actuator rod, wherein said pneumatic actuator is powered by compressed air stored within said compressed air storage tank, and wherein said pneumatic actuator cycles said actuator rod between a first position and a second position;
a compression cylinder, wherein a piston corresponding to said compression cylinder is mechanically coupled to said actuator rod of said pneumatic actuator, wherein said pneumatic actuator cycles said piston between a first piston position and a second piston position, wherein salt water from a salt water source is introduced into said compression cylinder through a cylinder input, and wherein pressurized salt water is expelled from a cylinder output of said compression cylinder; and
a reverse osmosis desalination column, wherein an input to said reverse osmosis desalination column is in fluid communication with said cylinder output, and wherein said reverse osmosis desalination column outputs desalinated water.

2. The desalination system of claim 1, further comprising a generator coupled to said wind turbine, wherein said generator is driven by said wind turbine and generates electricity.

3. The desalination system of claim 1, further comprising a generator mechanically coupled to an air turbine, wherein said air turbine is driven by compressed air stored within said compressed air storage tank, and wherein said generator generates electricity.

4. The desalination system of claim 1, further comprising a generator mechanically coupled to an air turbine, wherein said air turbine is driven by compressed air generated by said air compressor, and wherein said generator generates electricity.

5. The desalination system of claim 1, further comprising a first directional valve coupled to said pneumatic actuator, wherein said first directional valve drives said pneumatic actuator to cycle said actuator rod between said first position and said second position.

6. The desalination system of claim 1, further comprising a diverter, said diverter comprising a control valve, wherein said control valve has at least a first position and a second position, wherein said control valve in said first position couples said cylinder output to said input of said reverse osmosis desalination column, and wherein said control valve in said second position couples a source of pressurized desalinated water to said input of said reverse osmosis desalination column.

7. The desalination system of claim 1, further comprising a second compression cylinder, wherein a second piston corresponding to said second compression cylinder is mechanically coupled to said actuator rod of said pneumatic actuator, wherein a compression stroke corresponding to said compression cylinder at least partially coincides with an intake stroke corresponding to said second compression cylinder, wherein a compression stroke corresponding to said second compression cylinder at least partially coincides with an intake stroke corresponding to said compression cylinder, wherein salt water from said salt water source is introduced into said second compression cylinder through a second cylinder input corresponding to said second compression cylinder, wherein pressurized salt water is expelled from a second cylinder output corresponding to said second compression cylinder, and wherein said input to said reverse osmosis desalination column is in fluid communication with said second cylinder output.

8. The desalination system of claim 7, further comprising a first check valve coupled to said cylinder input, a second check valve coupled to said second cylinder input, a third check valve coupled to said cylinder output, and a fourth check valve coupled to said second cylinder output.

9. The desalination system of claim 7, further comprising an accumulator coupled to said cylinder output, said second cylinder output, and said input to said reverse osmosis desalination column, wherein said accumulator damps pressure fluctuations within the input to said reverse osmosis desalination column.

10. The desalination system of claim 7, further comprising a brine stream output corresponding to said reverse osmosis desalination column, wherein said brine stream output is in fluid communication with a first rear chamber input corresponding to said compression cylinder, wherein brine is introduced into said first rear chamber during said compression stroke corresponding to said compression cylinder, and wherein said brine stream output is in fluid communication with a second rear chamber input corresponding to said second compression cylinder, wherein brine is introduced into said second rear chamber during said compression stroke corresponding to said second compression cylinder.

11. The desalination system of claim 10, further comprising:
a first directional valve coupled to a first forward chamber corresponding to said compression cylinder, a second forward chamber corresponding to said second compression cylinder, said salt water source and said input to said reverse osmosis desalination column, wherein said first directional valve controls introduction of said salt water into said first and second forward chambers and controls expulsion of said pressurized salt water from said first and second forward chambers; and
a second directional valve coupled to a first rear chamber corresponding to said compression cylinder, a second rear chamber corresponding to said second compression cylinder, said brine stream output, wherein said second directional valve controls introduction of said brine into said first and second rear chambers.

12. The desalination system of claim 11, wherein said second directional valve is also coupled to said salt water source, wherein said second directional valve controls expulsion of said brine from said first and second rear chambers to said salt water source.

13. The desalination system of claim 7, further comprising a diverter, said diverter comprising a control valve, wherein said control valve has at least a first position and a second position, wherein said control valve in said first position couples said cylinder output and said second cylinder output to said input of said reverse osmosis desalination column, and wherein said control valve in said second position couples a source of pressurized desalinated water to said input of said reverse osmosis desalination column.

14. The desalination system of claim 1, wherein said pneumatic actuator further comprises a second actuator rod, and wherein said desalination system further comprises a second compression cylinder, wherein a second piston corresponding to said second compression cylinder is mechanically coupled to said second actuator rod of said pneumatic actuator, wherein a compression stroke corresponding to said compression cylinder at least partially coincides with an intake stroke corresponding to said second compression cylinder, wherein a compression stroke corresponding to said second compression cylinder at least partially coincides with an intake stroke corresponding to said compression cylinder, wherein salt water from said salt water source is introduced into said second compression cylinder through a second cylinder input corresponding to said second compression cylinder, and wherein pressurized salt water is expelled from a second cylinder output corresponding to said second compression cylinder, and wherein said input to said reverse osmosis desalination column is in fluid communication with said second cylinder output.

15. The desalination system of claim 14, further comprising a first check valve coupled to said cylinder input, a second check valve coupled to said second cylinder input, a third check valve coupled to said cylinder output, and a fourth check valve coupled to said second cylinder output.

16. The desalination system of claim 14, further comprising an accumulator coupled to said cylinder output, said second cylinder output, and said input to said reverse osmosis desalination column, wherein said accumulator damps pressure fluctuations within the input to said reverse osmosis desalination column.

17. The desalination system of claim 14, further comprising a brine stream output corresponding to said reverse osmosis desalination column, wherein said brine stream output is in fluid communication with a first rear chamber input corresponding to said compression cylinder, wherein brine is introduced into said first rear chamber during said compression stroke corresponding to said compression cylinder, and wherein said brine stream output is in fluid communication with a second rear chamber input corresponding to said second compression cylinder, wherein brine is introduced into said second rear chamber during said compression stroke corresponding to said second compression cylinder.

18. The desalination system of claim 17, further comprising:
a first directional valve coupled to a first forward chamber corresponding to said compression cylinder, a second forward chamber corresponding to said second compression cylinder, said salt water source and said input to said reverse osmosis desalination column, wherein said first directional valve controls introduction of said salt water into said first and second forward chambers and controls expulsion of said pressurized salt water from said first and second forward chambers; and
a second directional valve coupled to a first rear chamber corresponding to said compression cylinder, a second rear chamber corresponding to said second compression cylinder, said brine stream output, wherein said second directional valve controls introduction of said brine into said first and second rear chambers.

19. The desalination system of claim 18, wherein said second directional valve is also coupled to said salt water source, wherein said second directional valve controls expulsion of said brine from said first and second rear chambers to said salt water source.

20. The desalination system of claim 14, further comprising a diverter, said diverter comprising a control valve, wherein said control valve has at least a first position and a second position, wherein said control valve in said first position couples said cylinder output and said second cylinder output to said input of said reverse osmosis desalination column, and wherein said control valve in said second position couples a source of pressurized desalinated water to said input of said reverse osmosis desalination column.

21. A method of desalinating salt water, the method comprising the steps of:
powering an air compressor with a wind turbine;
generating compressed air with said air compressor;
storing said compressed air within a compressed air storage tank;
powering a pneumatic actuator with compressed air from said compressed air storage tank, wherein said pneumatic actuator cycles an actuator rod between a first position and a second position;
cycling a compression piston of a compression cylinder between a first piston position and a second piston position, wherein said compression piston is mechanically coupled to said actuator rod;
introducing salt water into said compression cylinder;
expelling pressurized salt water from said compression cylinder;
introducing said pressurized salt water into an input of a reverse osmosis desalination column; and
expelling desalinated water from an output of said reverse osmosis desalination column.

22. The method of claim 21, further comprising the steps of coupling a generator to said wind turbine, and generating electricity with said generator.

23. The method of claim 21, further comprising the steps of driving an air turbine with compressed air stored within said compressed air storage tank, coupling a generator to said air turbine, and generating electricity with said generator.

24. The method of claim 21, further comprising the steps of driving an air turbine with compressed air generated by said air compressor, coupling a generator to said air turbine, and generating electricity with said generator.

25. The method of claim 21, further comprising the step of periodically replacing the step of introducing said pressurized salt water into said input of said reverse osmosis desalination column with the step of introducing pressurized desalinated water into said input of said reverse osmosis desalination column.

26. The method of claim 21, further comprising the steps of:
cycling a second compression piston corresponding to a second compression cylinder, wherein said second compression piston is cycled by said pneumatic actuator;
introducing salt water into said second compression cylinder;
expelling pressurized salt water from said second compression cylinder;
introducing said pressurized salt water from said second compression cylinder into said input of said reverse osmosis desalination column; and
expelling desalinated water from said output of said reverse osmosis desalination column.

27. The method of claim 26, wherein said step of expelling pressurized salt water from said compression cylinder alternates with said step of expelling pressurized salt water from said second compression cylinder.

28. The method of claim 26, further comprising the step of damping pressure fluctuations within said input of said reverse osmosis desalination column.

29. The method of claim 26, further comprising the steps of:
introducing a brine stream output expelled by said reverse osmosis desalination column into a rear chamber corresponding to said compression cylinder, wherein said step of introducing said brine stream output into said rear chamber is performed during a compression stroke corresponding to said compression cylinder; and
introducing said brine stream output expelled by said reverse osmosis desalination column into a second rear chamber corresponding to said second compression cylinder, wherein said step of introducing said brine stream output into said second rear chamber is performed during a compression stroke corresponding to said second compression cylinder.
